(19) United States
(12) Patent Application Publication
(10) Pub. No.: US 2003/0140042 A1
(43) Pub. Date: Jul. 24, 2003

(54) System and method for providing pages with a common appearance at a network-based site

(76) Inventors: S. Brandon Keller, Evans, CO (US); Gregory Dennis Rogers, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/052,334

(22) Filed: Jan. 23, 2002

(51) Int. Cl. G06F 17/30

(52) U.S. Cl. 707/10

(57) ABSTRACT

A system and method for providing a network-based site having a common appearance. The system may include a tag embedded in each page of a network-based site, a script to be called from within the tag, and a configuration database storing page configuration information to be called or queried by the script. The pages of the network-based site may be stored in a page storage medium. The method may include receiving a request for a page, retrieving the page from a page storage medium and executing a database script associated with the page to access configuration information from a configuration database. The method may further include receiving configuration information associated with the page from the configuration database, wherein the page, including the configuration information, may be served to a user.

### FIELD OF THE INVENTION

The invention is generally related to website design. More particularly, the invention is related to configuration of web pages on a website.

### BACKGROUND OF THE INVENTION

It is often desired in website design to provide a common look and feel for each page of a website, without the need to cut and paste hypertext markup language (“HTML”) into each page to achieve the common appearance.

One approach to providing web pages having a common look is to use common gateway interface (“CGI”) scripts. In this approach, a user's browser queries a server side script with certain parameters, and an entire web page is then generated as a result of the query. However, when CGI scripts are used to generate web pages, a single URL is used for the entire website. Also, security needs to be integrated into the script if all pages are not to be accessible by all users.

Another approach is to use cascading style sheets. In this approach, a link to a style sheet may be embedded at the top of each web page. However, cascading style sheets are not able to provide a high degree of functionality. Also, if a change needs to be made to the appearance of all of the web pages in the website, either the style sheet needs to be changed, or each page of the website has to be changed.

### SUMMARY OF THE INVENTION

A system and method for providing a network-based site having a common appearance is described. The system may include a tag embedded in each page of a network-based site, a script to be called from within the tag, and a configuration database storing page configuration information to be called or queried by the script. The pages of the network-based site may be stored in a page storage medium.

The method may include receiving a request for a page, retrieving the page from a page storage medium and executing a database script associated with the page to access configuration information from a configuration database. The method may further include receiving configuration information associated with the page from the configuration database, wherein the page, including the configuration information, may be served to a user.

### BRIEF DESCRIPTION OF THE DRAWINGS

The invention is illustrated by way of example and not limitation in the accompanying figures in which like numeral references refer to like elements, and wherein:

FIG. 1 is a block diagram illustrating one embodiment of a network system employing principals of an embodiment of the invention;

FIG. 2 is a block diagram illustrating one embodiment of the network site of FIG. 1; and

FIG. 3 is a flow diagram illustrating one embodiment of the method for presenting pages of a network site so that the pages have a common look and feel;

FIG. 4 is a flow diagram illustrating one embodiment of additional processes for presenting pages of a network site so that the pages have a common look and feel.

### DETAILED DESCRIPTION OF THE INVENTION

In the following detailed description, numerous specific details are set forth in order to provide a thorough understanding of the invention. However, it will be apparent to one of ordinary skill in the art that these specific details need not be used to practice the invention. In other instances, well known structures, interfaces, and processes have not been shown in detail in order not to obscure unnecessarily the invention.

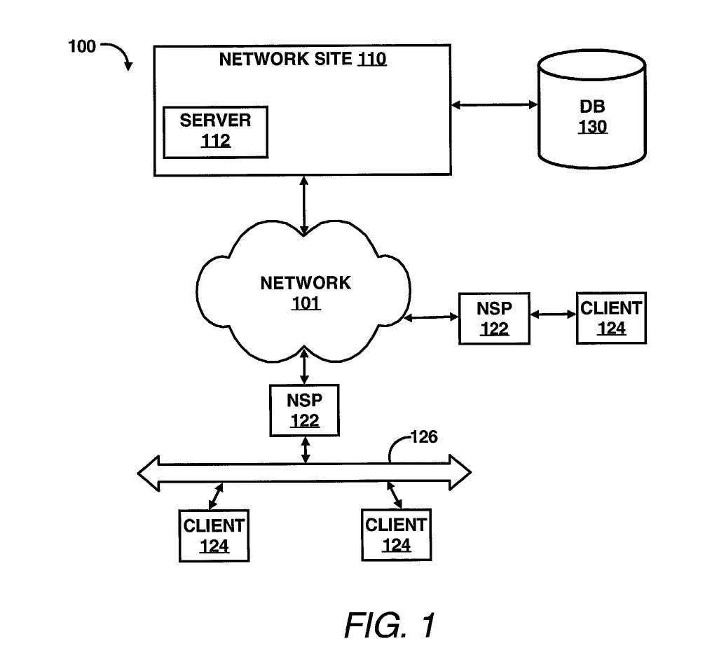

FIG. 1 is a block diagram illustrated one embodiment of a network system employing principals of an embodiment of the invention. This system 100 includes a network site 110, network 101 and network service providers 122.

The network 101 may include the internet or any other network such as a local area network (“LAN”), a wide area network (“WAN”), etc. The network site 110 may include a server 112 for serving pages, such as, for example, web pages, to users of network 101.

The server 112 may include, for example, a workstation running a Microsoft Windows™ NT™ operating system, a Windows™ 2000 operating system, or another similar operating system or platform. The network site 110 may also be connected to a database 130. Although the database is shown outside the network site 110, in one embodiment, the database 130 may be included with the network site 110. The database 130 may include or interface to, for example, an Oracle™ relational database such as sold commercially by Oracle Corporation, an Informix™ database, a Database 2 (DB2) database, etc. Network service providers 122 may provide communications between client systems 124 and network 101. The client system(s) 124 may include, for example, a personal computer running a Microsoft Windows™ 95 operating system, a Windows 98 operating system, a Millenium™ operating system, etc.

The client system(s) 124 may also include a microprocessor such as an Intel x86-based device, an Advanced Micro Devices x86-compatible device, etc. The client may further include electronic memory such as a random access memory (RAM) or an electronically programmable read only memory (EPROM), a storage device such as a hard drive, a compact disk read only memory device (CDROM), etc.

The client system(s) 124 may be equipped with an integral or a connectable cathode ray tube (CRT), a liquid crystal display (LCD), an electroluminescent display, a light emitting diode (LED) or another display screen, panel or device for viewing and manipulating files, data and other resources using a graphical user interface (GUI) or a command line interface (CLI). The client may also include a network-enabled appliance such as a WebTV™ unit, a browser-equipped or other network-enabled cellular telephone, etc.

In one embodiment, the client system(s) 124 maybe connected to network 101 through network service provider 122. In one embodiment, client system(s) 124 may be connected to network service provider 122 through another network 126. Network service providers 122 and network site 110 may be connected to the network 101 through a communications link. In one embodiment the network 101 may be or include a communications link. The communications link may include or interface to, for example, the Internet, an intranet, a Local Area Network (LAN), etc.

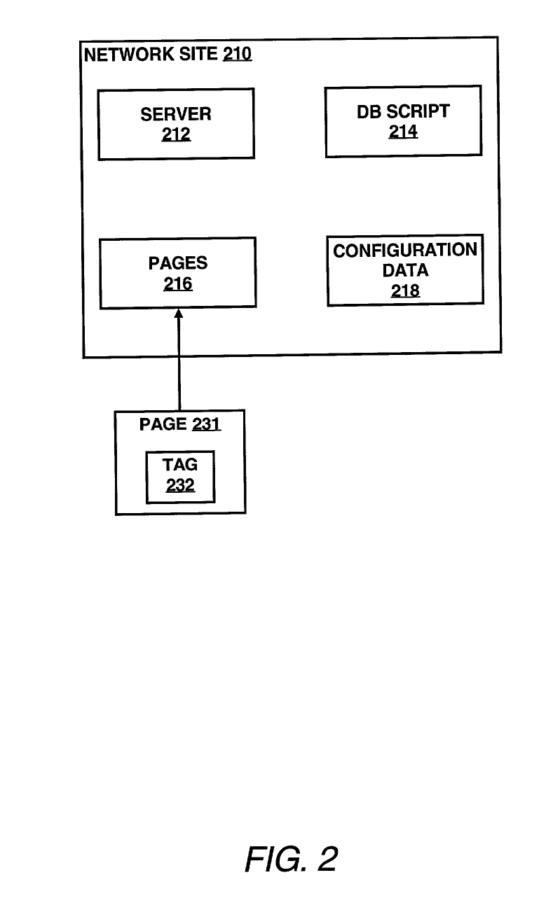

FIG. 2 is a block diagram illustrating one embodiment of the network site of FIG. 1. Network site 210 may include a server module 212, database script module 214, pages module 216 and configuring information module 218. The network site 210 may present pages 231, such as, for example, web pages, to users at the client systems 124 through server module 212.

The server module 212 may access the pages module 216 to retrieve a page 231 requested by the user. In one embodiment, the page 231 is embedded with a tag 232. The tag 232 may be a link to a database script stored in database script module 214. In operation, the server module 212 may detect the tag 232 and retrieve a database script associated with the tag 232 from database script module 214. Database script module 214 may be a component of the database 130.

The server 212 may then execute the database script retrieved from database script module 214 of database 130 to obtain configuring information from the configuring information module 218.

The database script retrieved from database script module 214 maybe executed using a database engine associated with database 130. The database engine may retrieve configuration information from a configuring information module 218 of network site 210.

The database script may use functions defined in the centralized database 130 to generate information to be displayed on page 231 in hypertext markup language (“HTML”). In one embodiment, the configuration information 218 may be stored in HTML. The configuration information 218 may be incorporated into the final HTML page 231 to be presented to browser of the client system 124.

For example, a typical page using the framework described above in HTML may appear as:

<!doctype html public “-//w3c//dtd html 4.0 transitional//en”>

| | |
|---|---|
| <!-- Begin Header --> | [header tag] |

<!--#include
virtual=“/cgi-bin/example/webframe?page=first_page&action=header” -->
<!-- End Header -->
<h4>This is a page</h4>
<p>Lots of stuff could go here...

| | |
|---|---|
| <!-- Begin Footer --> | [footer tag] |

<!--#include
virtual=“/cgi-bin/example/webframe?page=first_page&action=footer” -->

In the example above, the script in the tags for header and footer may call a database engine of database 130 to retrieve the header and footer information for the page 231, which is referenced in the database as “first₁₃ page.” Database 130 may include HTML content that may be printed where the “<#includevirtual= . . . ” lines are. The completed HTML page may be transmitted to the browser of client system 124 to be displayed.

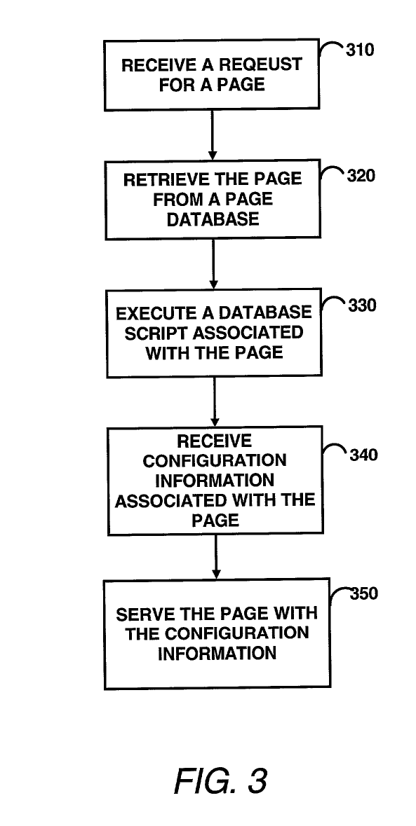

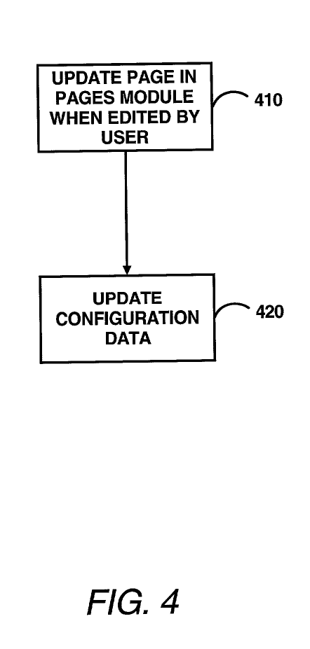

FIG. 3 is a flow diagram illustrating one embodiment of the method for presenting pages 231 of a network site 110, 210 so that the pages 231 have a common look and feel. It will be appreciated that the processes described below with reference to FIGS. 3 and 4 may be performed in any order and not all of the process steps are necessary for the operation of the present invention.

At processing block 310, a request for a page 231 is received by the network site 110, 210. At processing block 320, the server 212 of the network site 110, 210 retrieves the page 231 requested by the user from the pages module 216. In one embodiment, the pages module 216 may include a page storage medium, such as a file system. In one embodiment, the page storage medium may be a part of centralized database 130.

At processing block 330, the server 112 may execute a database script associated with the retrieved page 231. In one embodiment, the server 212 may detect the tag 232 in page 231. The server 212 may then execute a database script 214 contained in or associated with the tag 232.

In one embodiment, the server 212 may retrieve the database script from a database script module 214. In one embodiment, the server may assign a page name to the page 231 and use the page name inside the database script module 214 to retrieve configuring information for the page 231.

At processing block 340, the server 212 may receive the configuration information associated with the page 231. At processing block 350, the server 212 may serve the page 231 along with the configuration information. In one embodiment, the configuration information may be in HTML. The server may then incorporate the configuration information into the HTML of the page 231 for presenting to the browser of client system 124.

In one embodiment, the database script may comprise a common gateway interface (“CGI”) script. In one embodiment, the configuration information may include a header, a footer and/or information to be inserted within the body of the page. The information may include images, text or any other HTML construct.

In one embodiment, the configuration information allows a network site 110, 210 to provide management information such as, for example, who may access the page, who was the last to edit the page, when the page was last edited, and/or how many times a particular person visited the page. The particular may include, for example, the person who last edited the page.

FIG. 4 is a flow diagram illustrating additional processes that may be performed in one embodiment of a method for presenting pages 231 of a network site 110, 210 so that the pages 231 have a common look and feel. At step 410, the server 212 may update page 231 stored in pages module 216 when page 231 is edited by a user at a client system 124. In one embodiment, the user may edit the page 231 in the same manner as a user may edit any HTML document. In addition, the user may update the CGI script to change the appearance of page 231.

At step 420, a user may update configuration data 218 in database 130. The user may change the information provided by the database script 330, for example, to provide information on management events. Management events may include editing of page 231, a change in who may access the page 231, and/or access of the page 231 by a user.

Thus, a framework has been described allowing a database 130 to control configuration of a whole network site 110, 210 where the network site 110, 210 may include multiple pages 231. The framework allows configuration data 218 of all pages 231 of a network site 110, 210 to be changed without changing each page 231 of the network site 110, 210. This is accomplished using a mechanism for inclusion (tag(s) 232) provided by the server 212. Also, since each page on the network site 110, 210 has its own address, the server 112, 212 can perform security functions for the pages 231 of the network site 110, 210, so that additional security functions do not have to be added to each page 231.

The method described above, with reference to FIG. 3, may be compiled into computer programs (e.g., software residing in network site 110, 210). These computer programs can exist in a variety of forms both active and inactive. For example, the computer program can exist as software comprised of program instructions or statements in source code, object code, executable code or other formats. Any of the above can be embodied on a computer readable medium, which include storage devices and signals, in compressed or uncompressed form. Exemplary computer readable storage devices include conventional computer system RAM (random access memory), ROM (read only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the computer program can be configured to access, including signals downloaded through the Internet or other networks.

While this invention has been described in conjunction with the specific embodiments thereof, it is evident that many alternatives, modifications and variations will be apparent to those skilled in the art. These changes and others may be made without departing from the spirit and scope of the invention.

What is claimed is:

1. A system for providing a network-based site having pages with a common appearance, comprising:
a tag embedded in each page of a network-based site, each page stored in a page storage medium;
a script to be called from within the tag; and
a configuration database storing page configuration information to be called or queried by the script.

2. The system of claim 1 further comprising:
a server configured to retrieve a page from the page storage medium, detect the tag in the page, retrieve the script associated with the tag, execute the database script in a configuration database to access page configuration information and serve the page including the page configuration information.

3. The system of claim 1 wherein the script comprises database script.

4. The system of claim 1 further comprising a script database storing the script.

5. The system of claim 4 wherein the configuration database and the script database comprise the same database.

6. The system of claim 1 wherein each page comprises a HTML page.

7. A method for providing a network-based site having pages with a common appearance, comprising:
receiving a request for a page;
retrieving the page from a page storage medium;
executing a database script associated with the page to access configuration information from a configuration database; and
receiving configuration information associated with the page from the configuration database, wherein the page, including the configuration information, is to be served to a user.

8. The method of claim 7 wherein executing the database script comprises retrieving the database script through a tag on the page, the tag including a link to the database script.

9. The method of claim 7 wherein retrieving the page from the page storage medium comprises retrieving the page in a hypertext markup language format and receiving the configuration information comprises receiving information in a hypertext markup language format.

10. The method of claim 7 wherein the configuration information is integrated into the page when the page is served.

11. The method of claim 7 wherein executing the database script comprises giving the page a name and using the page name in the database script to access the configuration database.

12. The method of claim 7 wherein receiving configuration information comprises receiving information to be displayed in the body of the page.

13. A system for providing a network-based site having pages with a common appearance, comprising:
means for receiving a request for a page;
means for retrieving the page from a page storage medium;
means for executing a database script associated with the page to access configuration information from a configuration database; and
means for receiving configuration information associated with the page from the configuration database, wherein the page including the configuration information may be served to a user.

14. The system of claim 13 wherein the means for executing the database script comprises means for retrieving the database script through a tag on the page, the tag including a link to the database script.

15. The system of claim 13 wherein the means for retrieving the page from the page database comprises means for retrieving the page in a hypertext markup language format and the means for receiving the configuration information comprises means for receiving information in a hypertext markup language format.

16. The system of claim 13 wherein the configuration information is integrated into the page when the page is served.

17. The system of claim 13 wherein the means for executing the database script comprises means for giving the page a name and using the page name in the database script to access the configuration database.

18. The system of claim 13 wherein the means for receiving configuration information comprises means for receiving information to be displayed in the body of the page.

19. A computer readable storage medium containing executable computer program instructions which when executed cause a digital processing system to perform a method for providing a network-based site having pages with a common appearance, said method comprising:
receiving a request for a page;
retrieving the page from a page storage medium;
executing a database script associated with the page to access configuration information from a configuration database; and
receiving configuration information associated with the page from the configuration database, wherein the page, including the configuration information, is to be served to a user.
